(19) United States
(12) Patent Application Publication
(10) Pub. No.: US 2015/0353790 A1
(43) Pub. Date: Dec. 10, 2015

(54) METHODS AND SYSTEMS FOR ADJUSTING THE COMPOSITION OF A BINDER SYSTEM CONTAINING TWO OR MORE RESINS

(71) Applicant: Georgia-Pacific Chemicals LLC, Atlanta, GA (US)

(72) Inventors: Robert A. Breyer, Atlanta, GA (US); James H. Knight, Conyers, GA (US); Paul S. Baxter, Conyers, GA (US); Jessica D. Jennings, Social Circle, GA (US); Robert H. Carey, Buckhead, GA (US); John D. Cothran, Conyers, GA (US)

(73) Assignee: Georgia-Pacific Chemicals LLC, Atlanta, GA (US)

(21) Appl. No.: 14/831,258

(22) Filed: Aug. 20, 2015

Related U.S. Application Data
(63) Continuation of application No. 13/874,899, filed on May 1, 2013.
(60) Provisional application No. 61/642,265, filed on May 3, 2012.

(51) Int. Cl. C09J 175/04; C08K 5/00; B29C 65/02; C08K 3/00

(52) U.S. Cl. CPC C09J 175/04; C08K 3/0033; C08K 5/0008; B29C 65/02; B29K 2201/00

(57) ABSTRACT

Methods and systems for preparing a binder system are provided. The method can include combining a first resin and a second resin to produce a first binder system. The first binder system can be applied to a first plurality of lignocellulose substrates and at least partially cured to produce a first composite product. The method can also include monitoring one or more process variables. The one or more monitored process variables can be evaluated. An amount of the first resin, the second resin, or both combined with one another can be adjusted in response to the evaluation of the one or more monitored process variables to produce a second binder system.

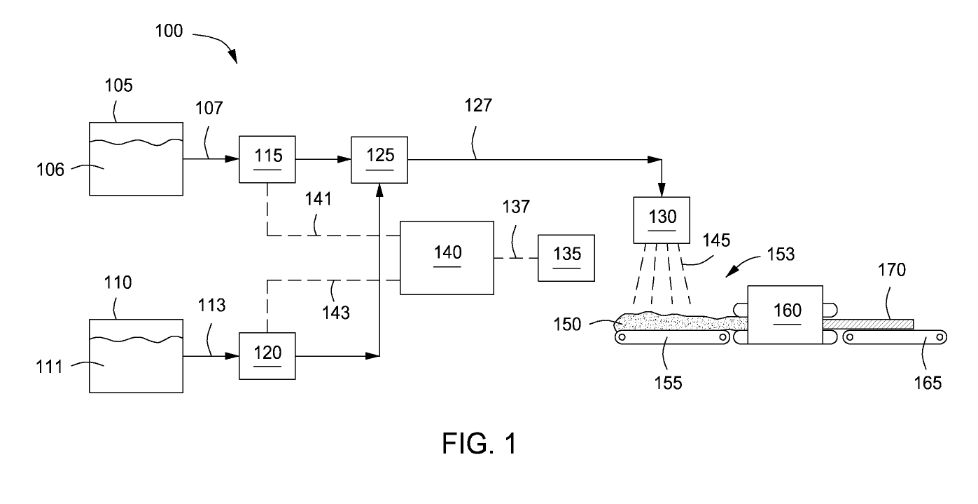

### CROSS-REFERENCE TO RELATED APPLICATIONS

This application is a continuation of co-pending U.S. patent application Ser. No. 13/874,899, filed on May 1, 2013, which claims priority to U.S. Provisional Patent Application having Ser. No. 61/642,265, filed on May 3, 2012, which are both incorporated by reference herein.

### FIELD

Embodiments described herein generally relate to methods and systems for adjusting the composition of a binder system containing two or more resins for use in making lignocellulose composite products. More particularly, such embodiments relate to methods and systems for adjusting the amount of a first resin and a second resin relative to one another based, at least in part, on one or more monitored process variables.

### BACKGROUND

Typical adhesives or binders used in the production of lignocellulose products such as medium density fiberboard (“MDF”), plywood, oriented strand board (“OSB”), and particle board include amino-formaldehyde resins such as urea-formaldehyde (“UF”), melamine-formaldehyde (“MF”), phenol-formaldehyde, melamine-urea-formaldehyde (“MUF”) resins, and the like. While these resins produce finished products having desirable properties, such as strength, these resins also tend to release formaldehyde into the environment during the production thereof, during application to a lignocellulose substrate, curing of the resin/substrate, as well as, from the finished product.

Various techniques have been used to reduce the amount of formaldehyde released from amino-formaldehyde resins and products that include amino-formaldehyde resins. For example, the addition of formaldehyde scavengers to the amino-formaldehyde resin and/or various modifications to the particular synthesis steps used to make the amino-formaldehyde resin such as the addition of urea as a reactant late in the resin synthesis are often used in an attempt to reduce formaldehyde emission. These attempts to reduce formaldehyde emission, however, are accompanied with undesirable effects such as longer cure times, reduced resin shelf-life, reduced product strength, reduced tolerance for processing variations, and/or inferior moisture resistance.

There is a need, therefore, for improved methods and systems for producing binders and products containing those binders that have reduced formaldehyde emission and/or one or more other improved properties.

### SUMMARY

Methods and systems for producing a binder system are provided. In one or more embodiments, the method can include combining a first resin and a second resin to produce a first binder system. The first binder system can be applied to a first plurality of lignocellulose substrates and at least partially cured to produce a first composite product. The method can also include monitoring one or more process variables. The one or more monitored process variables can be evaluated. An amount of the first resin, the second resin, or both combined with one another can be adjusted, at least in part, in response to the evaluation of the one or more monitored process variables to produce a second binder system.

In one or more embodiments, the method for preparing a binder system can include combining a first resin and a second resin to produce a first binder system, wherein the first binder system has a first weight ratio of the first resin to the second resin, based on a solids weight of the first and second resins. A first plurality of lignocellulose substrates can be contacted with the first binder system to produce a first mixture. The first binder system in the first mixture can be at least partially cured to produce a first composite product. The method can also include monitoring one or more process variables and evaluating the one or more monitored process variables. The amount of the first resin, the second resin, or both combined with one another can be adjusted to produce a second binder system. The second binder system can have a second weight ratio of the first resin to the second resin, based on the solids weight of the first and second resins. The adjustment in the amount of the first resin, the second resin, or both can be based, at least in part, on the evaluation of the one or more monitored process variables. A second plurality of lignocellulose substrates can be contacted with the second binder system to produce a second mixture. The second binder system in the second mixture can be at least partially cured to produce a second composite product.

In one or more embodiments, the system for producing a binder system can include a first resin vessel in fluid communication with a first flow control device, a second resin vessel in fluid communication with a second flow control device, and a mixer adapted to combine the first resin and the second resin to produce a binder system. The first and second flow control devices can be configured to adjust an amount of a first resin and a second resin combined within the mixer to produce the binder system. The amount of the first resin and the second resin combined with one another can be based, at least in part, on an evaluation of one or more monitored process variables.

### BRIEF DESCRIPTION OF THE DRAWINGS

The FIGURE depicts an illustrative system for varying the composition of a binder system used to produce lignocellulose composite products, according to one or more embodiments described.

### DETAILED DESCRIPTION

The adhesive or binder system can include two or more components. For example, the binder system can include a first resin and a second resin, where the first and second resins differ from one another. The first resin and the second resin can be mixed, blended, contacted, or otherwise combined with one another to produce the binder system. In another example, the binder system can include a first resin, a second resin, a third resin, and optionally any number of other resins, e.g., a fourth resin, a fifth resin, a sixth resin, or more, where the resins differ from one another. Another binder system can include a resin and one or more additives. The resin and additive can be mixed, blended, contacted, or otherwise combined with one another to produce the binder system. Another binder system can include a first resin, a second resin, and one or more additives. The first resin, second resin, and additive can be mixed, blended, contacted, or otherwise combined with one another to produce the binder system. The binder system can be applied to a plurality of lignocellulose substrates and at least partially cured to produce a composite product.

The first resin can be present in the binder system in an amount ranging from about 0.1 wt % to about 99.9 wt %, based on the combined solids weight of the first resin and the second resin. For example, the first resin can be present in an amount ranging from a low of about 0.5 wt %, about 1 wt %, about 5 wt %, about 10 wt %, about 15 wt %, about 25 wt %, or about 35 wt % to a high of about 65 wt %, about 75 wt %, about 85 wt %, or about 95 wt %, based on the combined solids weight of the first and second resins. When three or more resins are combined to provide the binder system, the three or more resins can be present in any amount. For example, in the context of a binder system that includes a first, second, and third resin, the first resin can be present in an amount of from about 0.5 wt % to about 99 wt %, the second resin can be present in an amount of from about 0.5 wt % to about 99 wt %, and the third resin can be present in an amount of from about 0.5 wt % to about 99 wt %, based on the combined solids weight of the first, second, and third resins. For simplicity and ease of description, the binder system will be further discussed and described in the context of a two resin binder system, i.e., as a binder system having a first resin and a second resin, combined with one another. However, the binder system can also be or include one or more additives in lieu of or in addition to the second resin. As such, in the context of the two resin binder systems discussed and described herein, the second resin can be substituted for an additive or a combination of additives.

The first and second resins can have at least one property or characteristic different from one another. The first resin can include one or more compounds or components that are not present in the second resin. For example, the first resin can include formaldehyde and the second resin can be free from formaldehyde or free from any intentionally added formaldehyde. The first and second resins can both include the same compound(s), but the relative amount(s) of the compound(s) in each resin can differ with respect to one another. For example, the first and second resins can both be phenol-formaldehyde resins, but a molar ratio between the phenol and formaldehyde in the first and second resins can differ. The first and second resins can both include the same compound(s) in the same ratio(s) with respect to one another, but the particular compound formed in the first resin can be different from the particular compound formed in the second resin. For example, both the first and second resins can be a styrene acrylate polymer combined with one another at the same ratio, but the first resin can include a styrene acrylate copolymer having a bimodal molecular weight distribution while the second resin can include a monomodal styrene acrylate copolymer, i.e., a copolymer not having a bimodal molecular weight distribution. Other differences that can distinguish the first and second resin from one another can include, but are not limited to, the degree or level of resin advancement or condensation, molecular weight, e.g., high molecular weight versus low molecular weight, resin alkalinity, and the like.

The particular composition of the binder system can be based, at least in part, on one or more monitored process variables. The composition of the binder system can be changed, altered, or otherwise adjusted as one or more of the monitored process variables change. The composition of the binder system can be adjusted before and/or during production of the composite products. The composition of the binder system can be adjusted on a periodic time cycle, a variable time cycle, or a combination thereof. For example, the composition of the binder system can be adjusted on a continuous basis during production of the composite products, periodically, e.g., every ten minutes, hourly, or daily, when a process variable changes, when two or more process variables change, and the like. Adjusting the binder composition in response to the monitored process variables can at least partially account for any effect a change in the process variable(s) may have on one or more properties of the composite product. In other words, preparation or production of the binder system can include, but is not limited to, monitoring one or more process variables and adjusting or controlling the composition of the binder system based, at least in part, on at least one of the one or more monitored process variables.

Adjusting or controlling the composition of the binder system based, at least in part, on the one or more monitored process variables can produce one or more composite products and/or the process(es) for making or producing the composite products) having one or more improved or enhanced properties as compared to using a binder containing only a single resin and/or a pre-mixed or pre-combined binder containing two or more different resins at a fixed or non-adjustable weight ratio. In other words, one or more properties of the composite products) and/or the process for producing the composite product(s) can be improved by monitoring one or more process variables and controlling the composition of the binder system, based at least in part, on the monitored process variable(s).

For example, when the first and/or second resin contains formaldehyde, adjusting the weight ratio of the first resin to the second resin in the binder, based at least in part on the monitored process variables, can be used to provide a production process and/or a composite product having one or more desired, acceptable, and/or required properties while also reducing or minimizing a level of formaldehyde emitted from the process of producing the composite product and/or the composite product itself. In another example, controlling the composition of the binder system can be used to optimize one or more process variables such as internal bond strength, time required to at least partially cure the binder system in order to produce the composite product, and/or the like, that can be affected by one or more other varying or changing process variables such as one or more environmental or weather conditions, one or more substrate properties such as moisture content and/or temperature, and/or one or more composite product properties such as product type, shape, and/or size.

For example, a composite product produced under a first set of process variables with a binder system having a first composition will have a first set of properties. If one or more of the process variables is altered such that a second set of process variables is present, the same composite product produced under the second set of process variables can have a second set of properties, where the first and second set of properties differ from one another. Adjusting the composition of the binder system to produce a binder system having a second composition can produce a composite product having the first set of properties, when produced under the second set of process variables. In another example, adjusting the composition of the binder system to produce the binder system having the second composition can produce a composite product having an intermediate set of properties, where the intermediate set of properties conforms more closely to the first set of properties in at least one aspect as compared to the second set of properties. As such, adjusting the composition of the binder system to provide a second binder composition can facilitate production of a composite product under the second set of process variables having one or more properties closer to the first set of properties as compared to the second set of properties.

In another example, adjusting the composition of the binder system can be used to tailor, modify, alter, or otherwise adjust one or more properties of the composite product. For example, internal bond strength of a composite lignocellulose product can be increased or decreased by adjusting a given composition of the binder system used to produce the composite product. If the one or more process variables remain constant, i.e., no change, the composition of the binder system could be adjusted to produce a composite product having one or more different properties. For example, a particular composition of the binder system can be optimized or otherwise improved to increase internal bond strength of a composite product under a constant set of monitored process variables.

The one or more process variables can be monitored continuously, intermittently, randomly, periodically, upon the occurrence of one or more predetermined events, or any combination thereof. For example, the flow rates of the first resin and the second resin can be monitored periodically, e.g., every 5 seconds, 30 seconds, minute, or 5 minutes during production of the composite product and/or production of the binder system. In another example, a particular process variable or multiple process variables can be monitored upon the occurrence of a predetermined event. Illustrative predetermined events can include, but are not limited to, a transition between the production of a first finished product and the production of a second finished product, a transition or change in a substrate temperature above or below a pre-set or predetermined value, a transition or change in atmospheric temperature to above or below a pre-set or predetermined value, a transition or change in a material from which the lignocellulose substrates are derived, and the like.

Evaluation of the one or more monitored process variables can include any method or combination of methods capable of providing an indication as to an appropriate or desired composition of the binder system. For example, at least one of the one or more monitored process variables can be compared to a predetermined database containing previously monitored process variables. The predetermined database can undergo periodic, continuous, and/or random updates with additional process variables. For example, as the one or more process variables are monitored, at least a portion of the monitored process variables can be input or otherwise added to the predetermined database. In another example, a given number of any particular process variables can be averaged with one another and an average process variable can be input or otherwise added to the predetermined database.

The monitored process variable(s) can be compared to the previously determined monitored process variables in the predetermined database and the appropriate adjustment to the composition of the binder system in response to the monitored process variable(s) can be determined. For example, by comparing the monitored process variable(s) to the predetermined database of monitored process variables a determination or estimation as to an adjustment in the composition of the binder system can be made, if needed, to produce a composite product having one or more preferred properties when produced under the monitored process variables.

Evaluation of the one or more monitored process variables can also include manipulating at least one of the one or more monitored process variables to produce a manipulated process variable(s). The manipulated process variable(s) can be compared to the predetermined database that can include previously measured values for the manipulated process variable(s). In another example, evaluating the one or more monitored process variables can include comparing the monitored process variable(s) as acquired, averaged with one or more other values for a given process variable, after manipulation, or a combination of monitored process variable(s) as acquired, averaged with one or more other values for a given process variable, and after manipulation thereof to the predetermined database.

The pre-determined database can indicate a desired or preferred composition for the binder system being used to produce the composite product based on previously measured process variables acquired from one or more prior product production runs produced under the same and/or different process variables. The pre-determined database can include a listing of one or more values for one or more process variables and/or the predetermined database can be a generalized or averaged database listing ranges of values for one or more process variables.

The predetermined database can include any number of different process variables. For example, the predetermined database can include one, two, three, four, five, six, seven, eight, nine, ten, tens, hundreds, thousands or more different process variables that can be monitored. In another example, the number of different monitored process variables can range from a low of 1, 2, 3, 4, or 5 to a high of about 10, about 25, about 50, about 100, about 250, about 500, about 750, about 1,000, about 2,500, or about 5,000. In another example, the number of different monitored process variables can range from about 5 to about 100, about 1 to about 400, about 2 to about 20, about 3 to about 30, about 1 to 1,500, about 3 to about 10, about 4 to about 25, or about 7 to about 40. In another example, the number of monitored process variables can include at least two, at least 3, at least 4, at least 5, at least 6, at least 7, at least 8, at least 9, at least 10, at least 12, at least 14, at least 16, at least 18, at least 20, at least 22, at least 23, at least 24, or at least 26 different process variables.

The predetermined database can include any number of values for any give process variable that can be monitored. For example, the predetermined database can include one, two, three, four, five, six, seven, eight, nine, ten, tens, hundreds, thousands, tens of thousands, hundreds of thousands, millions or more values for any give process variable that can be monitored. As such, a particular monitored process variable or combination of monitored process variables can be compared or evaluated with respect to the pre-determined database and a determination as to a preferred or desired binder composition can be made, at least in part, based on that comparison or evaluation.

The one or more monitored process variables can be compared or otherwise evaluated against the predetermined database of monitored process variables using any suitable method. For example, one or more software programs can be used to evaluate the monitored process variables. Evaluation of the one or more monitored process variables can include use or application of one or more mathematical algorithms to manipulate the monitored process conditions in order to determine or generate an estimated change or adjustment that should be made to the amount of the first resin and/or the second resin combined to produce the binder having a preferred or desired composition based on the one or more monitored conditions. Illustrative mathematical algorithms can include, but are not limited to, linear regression, non-linear regression, multiple linear regression, multiple non-linear regression, neural network, or any combination thereof.

Referring to multiple linear regression modeling in particular, multiple linear regression modeling can be used to evaluate a plurality of process variables to determine or estimate the preferred or desired composition for the binder system based, at least in part, on the plurality of monitored process variables. For example, for a two resin binder system containing formaldehyde, i.e., a binder composition produced by combining a first resin and a second resin, with at least one of the first and second resins containing formaldehyde, the process variables could include the level of formaldehyde emissions desired (Fₑₘᵢₛₛᵢₒₙ), a moisture content of the substrate (M_{substrate}), a substrate temperature (T_{substrate}), and finished product thickness (P_{thickness}). An illustrative multiple linear regression model that includes these process variables can be represented by Equation 1:

Fₑₘᵢₛₛᵢₒₙ=C+b₁(R)+b₂(M_{substrate})+b₃(T_{substrate})+b₄(P_{thickness}) (Equation 1)

where C, b₁, b₂, b₃, and b₄ are all constants derived from the linear regression model, R is equal to the ratio of the first resin to the second resin. In this example, one would know the desired level of formaldehyde emission (Fₑₘᵢₛₛᵢₒₙ), the moisture content of the substrate (M_{substrate}), the temperature of the substrate (T_{substrate}), and the thickness of the finished product (P_{thickness}) and could determine the correct weight ratio of the first resin to the second resin (R) in order to achieve the desired level (or reduction thereof) of formaldehyde emission.

Equation 1 can be modified to also include interactions of the different process variables by adding additional terms such as b₅(M_{substrate})(T_{substrate}). Equation 1 can also be modified to include higher order terms such as b₆(M_{substrate})(M_{substrate}), which could be used if the relationship between M_{substrate} and M_{substrate} is not linear, but curved.

Evaluating the monitored process variables or data can also include ranking, grouping, ordering, or otherwise organizing any two or more monitored process variables with respect to one another. For example, two or more monitored process variables can be ranked with respect to one another based on the effect the particular process variables have on one or more process parameters, e.g., formaldehyde emission, press speed, cure speed, and/or one or more finished product properties such as product strength and/or moisture resistance. For example, the substrate temperature can have a greater affect on a required cure time than the environmental humidity. As such, if the substrate temperature and environmental humidity were ranked, the substrate temperature would be ranked higher, i.e., carry more weight, as to the relevance or importance as compared to the environmental humidity. Accordingly, the particular substrate temperature and its increased importance on the overall process can be taken into account when evaluating both process variables, i.e., substrate temperature and environmental humidity.

In at least one example, the monitored process variables can be evaluated using computer software. Illustrative software programs can include, but are not limited to, Statistica, Stat Graphics, SAS, R, and Wind Bugs. Systems designed by the resin blending facility or plant, e.g., non-commercialized proprietary software can also be used. In another example, personnel can manually compare the monitored process variables to the predetermined database.

Referring to the neural network modeling, the monitored process variables can be evaluated to see what particular process variables correlate to particular change(s) made to other process conditions during production of a composite product. For example, if the composition of the binder system is adjusted in response to a change in a process condition, e.g., substrate temperature, the neural network modeling can monitor the process variables and determine what particular process variables are affected the most versus those that are affected the least. As such, the neural network modeling can, at least in part, by its own logic determined the importance of monitored process variables and how monitored process variables affect one another. As such, the neural network modeling can rank monitored process variables according to importance. Linear effects and/or non-linear effects observed as the result of a particular process variable or combination of process variables can also be determined. For example, personnel can input desired vales for particular process variables, e.g., a particular internal bond strength, and the neural network can control or otherwise indicate a desired binder system composition for a give set of monitored process variables. As the monitored process variables change the neural network can adapt or learn from the changing process variables.

The monitored process variables can be or include any one or more of a number of conditions or parameters that can change during production of the binder system and/or the composite product. The monitored process variables can include variables that occur prior to production of the binder system and the composite product such as the geographical location from which the lignocellulose material that makes up at least a portion of the plurality of lignocellulose substrates was grown or otherwise produced. The monitored process variables can also include variables that occur after production of the binder system and the composite product such as internal bond strength, formaldehyde emission, and/or moisture resistance of the composite product. The monitored process variables can also include variables that occur during production of the binder system and/or the composite product such as atmospheric humidity and/or temperature, a temperature of the lignocellulose substrates during application of the binder system, and/or moisture content of the lignocellulose substrates. As such, the monitored process variables can include variables that are acquired before, during, and/or after the binder system and/or composite produced are produced. Any one or combination of two or more process variables can be used to determine or estimate the desired or preferred composition for the binder system based on the particular monitored process variable or combination of monitored process variables.

The particular monitored process variable(s) used to determine or estimate the desired or preferred composition of the binder system can be the most recently monitored process variables, monitored process variables acquired prior or previous in time as compared to the most recently acquired monitored process variables, or a combination thereof. Preferably, at least one of the monitored process variables used to determine or estimate the desired or preferred binder composition is the most recently acquired monitored process variable for that particular process condition, e.g., the most recent lignocellulose substrate temperature rather than a previously acquired substrate temperature.

Illustrative process variables can include, but are not limited to, press speed, moisture content in the lignocellulose substrates, temperature of the lignocellulose substrates, a size of the lignocellulose substrates, a shape of the lignocellulose substrates, the location from where the lignocellulose material used to produce the lignocellulose substrate was acquired, the particular species from which the lignocellulose substrates are derived, an age of the lignocellulose substrates, a condition or state of the lignocellulose substrates such as whether any rot or mold may be present, environmental or atmospheric conditions such as ambient temperature, ambient humidity, and/or ambient pressure, spread or application rate of the binder system to the substrates, product cure speed, product cure temperature, pressure applied to the lignocellulose substrates during production of the composite product, product density, product thickness, formaldehyde emissions during production of the binder system and/or from the composite product (when at least one resin contains formaldehyde), strength of the composite product, internal bond strength of the composite product, thickness of the composite product, the particular type of composite product such as plywood, fiberboard, or OSB, moisture resistance of the finished product, dimensional stability of the finished product, appearance (such as color) of the finished product, the composition of the first resin, the composition of the second resin, or any combination thereof.

If two or more process conditions are monitored, the two or more process conditions can both be determined at the same point in time or different points in time with respect to one another. For example, the environmental temperature can be measured periodically, e.g., about once every hour, such as the “top” of the hour, and the environmental humidity can also be measured periodically but at different times than the environmental temperature, e.g., every 30 minutes past the hour or at the “bottom” of the hour. In another example, two or more process conditions, e.g., substrate temperature and moisture content of the substrate, can be measured periodically at the same time, e.g., every 15 minutes. In another example, two or more process conditions that can require monitoring at different points in time with respect to one another can include, but are not limited to, substrate temperature and internal bond strength of the finished product. For example, the internal bond strength of a finished product cannot be measured until the finished product is produced and the temperature of the substrate of that particular finished product cannot be measured after the finished product is produced. As such, both the temperature of a substrate and the internal bond strength of the finished product that includes the substrate would require monitoring those respective properties at different points in time with respect to one another. However, monitoring the temperature of a substrate and monitoring the internal bond strength of a finished product that does not include the substrate being monitored could be carried out at the same time or substantially the same time.

Internal bond strength of the finished product can be measured by pulling the composite apart in a direction perpendicular to the plane formed by the test piece. The internal bond strength and/or the water absorption of the finished product can be measured according to ASTM D1037. Swell due to water absorption can be measured by measuring the thickness of the finished product before and after the water absorption test. The temperature of the lignocellulose substrates can be measured using any type of thermocouple or other temperature sensing device. For example, the temperature of the lignocellulose substrates can be measured using an infrared temperature sensor.

Production of a first composite product having one or more desired, acceptable, and/or required properties can require a first binder system having a first weight ratio of the first resin to the second resin. If one or more process variables change, the weight ratio of the first resin to the second resin may require adjustment or change in order to maintain production of the first finished product and/or the process of making the finished product having similar or substantially similar properties or characteristics. For example, a first plywood product having a first thickness (first composite product) that requires a particular cure time or cure speed can be produced. A second plywood product (second composite product) having a second thickness, which differs from the first thickness, can also be produced. To produce the second plywood product having similar or substantially similar properties or characteristics as compared to the first plywood product may require contacting the wood substrates with a second binder system having a different weight ratio of the first resin to the second resin, as compared to the first binder system. As such, varying the weight ratio of the first and second resins in the binder system, based at least in part on the monitored process variable(s), e.g., the thickness of the second plywood product, can be used to produce plywood products having differing thickness, but otherwise have similar or substantially similar properties such as internal bond strength, cure speed, moisture resistance, formaldehyde emission, and the like.

The particular composite product, the binder system preparation equipment, binder system application equipment, composite product forming equipment, binder system curing equipment, and/or other factors can influence or dictate what the monitored process variables should be in order to estimate or determine the particular or preferred composition of the binder system. For example, for a binder system containing formaldehyde, the monitored process variables can include, but are not limited to, the level of formaldehyde emissions observed during production of the composite product and/or from the formed composite product, the binder system spread or application rate onto the plurality of lignocellulose substrates, the amount of binder system applied to the lignocellulose substrates, and/or a temperature of the lignocellulose substrates. One or more of these monitored process variables, alone or in conjunction with one another and/or other process variables, can then be evaluated to estimate or determine the preferred composition of the binder system for producing the composite product under the monitored process variables.

Due to the wide range of potential process variables that can be monitored, a wide range of different sensors and/or sensors configured to monitor multiple process variables can be used to monitor one or any combination of process variables. Illustrative sensors or detectors can include, but are not limited to, press speed sensors, moisture sensors, temperature sensors, lignocellulose substrate size and/or shape sensors, lignocellulose substrate age and/or condition sensors, binder system spread or application rate sensors, cure speed sensors, cure temperature sensors, product density sensors, product thickness sensors, formaldehyde emission sensors, composite product strength sensors or testing equipment, internal bond strength testing equipment, composite product thickness or other dimensional sensors, particular type of composite product sensors, sensors and/or testing equipment for determining product strength, internal bond strength, moisture resistance, dimensional stability of the product, and the like. For example, flow meters or flow control devices can be used to monitor a flow rate of the first resin, second resin, the binder system, and/or the binder system when applied to the plurality of lignocellulose substrates. The temperature sensors can be used to monitor a temperature of the environment, the substrate, the first resin, the second resin, the binder system, the lignocellulose substrates, the finished product, and the like. The lignocellulose substrate line speed sensors can be used to measure a time required for the substrate to travel a given distance through or down a product production line, e.g., a conveyor. Press rate sensors can monitor the speed or elapsed time between introduction of a first substrate to the press, pressing of the substrate, removal of the substrate, and introduction of a second substrate to the press. The formaldehyde emission sensors can monitor an amount of formaldehyde emitted into the environment from the first resin, the second resin, the binder, the substrate containing the binder, and/or the finished product. Another method that can be used to monitor one or more process variables can be to manually monitor the process variable(s). For example, a person or personnel can note the location the lignocellulose material from which the lignocellulose substrate is acquired, the particular dimensions of the finished product being produced, and the like.

The first and second resins can be any type of resin suitable for bonding, adhering, gluing, or otherwise securing the plurality of lignocellulose substrates to one another to produce the composite product. Illustrative resins can include, but are not limited to, aldehyde containing or aldehyde based resins; a mixture of Maillard reactants; a reaction product of Maillard reactants; a copolymer of one or more vinyl aromatic derived units and at least one of maleic anhydride and maleic acid; a polyamide-epichlorhydrin polymer; an adduct or polymer of styrene, at least one of maleic anhydride and maleic acid, and at least one of an acrylic acid and an acrylate; a polyacrylic acid based binder; polyvinyl acetate; polymeric methylene diisocyanate (“pMDI”); or any combination thereof. The first and second resins can be a liquid, a solid, or a combination thereof, i.e., a two phase solid/liquid resin.

Illustrative aldehyde containing or aldehyde based resins can include, but are not limited to, urea-aldehyde resins, melamine-aldehyde resins, phenol-aldehyde resins, resorcinol-aldehyde polymers, or combinations thereof. Combinations of aldehyde based resins can include, for example, melamine-urea-aldehyde, phenol-urea-aldehyde, phenol-melamine-aldehyde, urea-resorcinol-aldehyde, and the like.

The aldehyde component of the aldehyde-containing resins, e.g., urea-aldehyde resins, melamine-aldehyde resins, and/or phenol-aldehyde resins can include any suitable aldehyde or combination of aldehydes. The aldehyde component can include a variety of substituted and unsubstituted aldehyde compounds. Illustrative aldehyde compounds can include the so-called masked aldehydes or aldehyde equivalents, such as acetals or hemiacetals. Specific examples of suitable aldehyde compounds can include, but are not limited to, formaldehyde, acetaldehyde, propionaldehyde, butyraldehyde, furfuraldehyde, benzaldehyde, or any combination thereof. As used herein, the term “formaldehyde” can refer to formaldehyde, formaldehyde derivatives, other aldehydes, or combinations thereof. Preferably, the aldehyde component is formaldehyde.

Formaldehyde for making suitable formaldehyde containing resins is available in many forms. Paraform (solid, polymerized formaldehyde) and formalin solutions (aqueous solutions of formaldehyde, sometimes with methanol, in 37%, 44%, or 50% formaldehyde concentrations) are commonly used forms. Formaldehyde gas is also available. Any of these forms is suitable for use in preparing a formaldehyde containing resin.

The urea component of a urea-aldehyde resin can be provided in many forms. For example, solid urea, such as prill, and/or urea solutions, typically aqueous solutions, are commonly available. Further, the urea component can be combined with another moiety, for example, formaldehyde and/or urea-formaldehyde adducts, often in aqueous solution. Any form of urea or urea in combination with formaldehyde can be used to make a urea-formaldehyde resin. Both urea prill and combined urea-formaldehyde products can be used. Suitable urea-formaldehyde resins can be prepared from urea and formaldehyde monomers or from urea-formaldehyde precondensates in manners well known to those skilled in the art. Illustrative urea-formaldehyde products can include, but are not limited to, Urea-Formaldehyde Concentrate (UFC). These types of products can be as discussed and described in U.S. Pat. Nos. 5,362,842 and 5,389,716, for example. Any of these forms of urea, alone or in any combination, can be used to prepare a urea-aldehyde polymer.

Urea-formaldehyde resins can include from about 45% to about 70%, and preferably, from about 55% to about 65% non-volatiles, generally have a viscosity of about 50 centipoise (cP) to about 600 cP, preferably about 150 cP to about 400 cP. Urea-formaldehyde resins can have a pH of about 6 to about 9 or about 7 to about 9, or preferably about 7.5 to about 8.5. Urea-formaldehyde polymers can have a free formaldehyde level of less than about 5%, less than about 4%, or less than about 3.0%. Urea-formaldehyde resins can also have a water dilutability of about 1:1 to about 100:1, preferably about 5:1 and above. Many suitable urea-formaldehyde resins are commercially available. Urea-formaldehyde resins such as the types sold by Georgia Pacific Chemicals LLC (e.g. GP® 2928 and GP® 2980) for glass fiber mat applications, those sold by Hexion Specialty Chemicals, and by Arclin Company can be used.

In preparing a urea-aldehyde resin, the formaldehyde and the urea component can be reacted in an aqueous mixture under alkaline conditions using known techniques and equipment. The urea -aldehyde polymer can be made using a molar excess of formaldehyde (along with any other reactive aldehyde component(s)) relative to the urea component, e.g., melamine The molar ratio of formaldehyde to urea (F:U) in the urea -formaldehyde polymer can range from about 0.3:1 to about 6:1, about 0.5:1 to about 4:1, about 1:1 to about 5:1, about 1.1:1 to about 6:1, from about 1.3 to about 5:1, or from about 1.5:1 to about 4:1. When synthesized, such resins typically contain a low level of residual “free” urea component and a much larger amount of residual “free,” i.e. unreacted formaldehyde. Prior to any formaldehyde scavenging, the urea -formaldehyde resin can be characterized by a free formaldehyde content ranging from about 0.2 wt % to about 18 wt % of the aqueous urea-formaldehyde resin.

The phenol component of a phenol-aldehyde resin can include a variety of substituted phenolic compounds, unsubstituted phenolic compounds, or any combination of substituted and/or unsubstituted phenolic compounds. For example, the phenol component can be phenol itself (i.e. mono-hydroxy benzene). Examples of substituted phenols can include, but are not limited to, alkyl-substituted phenols such as the cresols and xylenols; cycloalkyl-substituted phenols such as cyclohexyl phenol; alkenyl-substituted phenols; aryl-substituted phenols such as p-phenyl phenol; alkoxy-substituted phenols such as 3,5-dimethyoxyphenol; aryloxy phenols such as p-phenoxy phenol; and halogen-substituted phenols such as p-chlorophenol. Dihydric phenols such as catechol, resorcinol, hydroquinone, bis-phenol A and bis-phenol F also can also be used.

Specific examples of suitable phenolic compounds (phenol components) for replacing a portion or all of the phenol used in preparing a phenol-aldehyde polymer can include, but are not limited to, bis-phenol A, bis-phenol F, o-cresol, m-cresol, p-cresol, 3,5-5 xylenol, 3,4-xylenol, 3,4,5-trimethylphenol, 3-ethyl phenol, 3,5-diethyl phenol, p-butyl phenol, 3,5-dibutyl phenol, p-amyl phenol, p-cyclohexyl phenol, p-octyl phenol, 3,5 dicyclohexyl phenol, p-phenyl phenol, p-phenol, 3,5-dimethoxy phenol, 3,4,5 trimethoxy phenol, p-ethoxy phenol, p-butoxy phenol, 3-methyl-4-methoxy phenol, p-phenoxy phenol, naphthol, anthranol and substituted derivatives thereof. Preferably, about 80 wt % or more, about 90 wt % or more, or about 95 wt % or more of the phenol component comprises phenol (monohydroxybenzene).

In preparing a phenol-aldehyde resin, the formaldehyde and the phenol component can be reacted in an aqueous mixture under alkaline conditions using known techniques and equipment. The phenol-aldehyde polymer can be made using a molar excess of formaldehyde (along with any other reactive aldehyde component(s)) relative to the phenol component, e.g., phenol. The molar ratio of formaldehyde to phenol (F:P) in the phenol-formaldehyde polymer can range from about 0.8:1 to about 6:1, about 0.8:1 to about 4:1, about 1.1:1 to about 6:1, from about 1.3 to about 5:1, or from about 1.5:1 to about 4:1. When synthesized, such polymers typically contain a low level of residual “free” phenol component and a much larger amount of residual “free,” i.e. unreacted formaldehyde. Prior to any formaldehyde scavenging, the phenol-formaldehyde polymer can be characterized by a free formaldehyde content ranging from about 0.2 wt % to about 18 wt % of the aqueous phenol-formaldehyde polymer.

Suitable phenol-formaldehyde resins can be as discussed and described in U.S. Patent Application Publication Nos. 2008/0064799 and 2008/0064284. In these published patent applications, the formation of tetradimer is suppressed by the addition of a sulfite source during the preparation of the phenol-formaldehyde resin. Other phenol-formaldehyde resins can be prepared under acidic reaction conditions, such as novolac resins and inverted novolac resins. Suitable novolac resins and inverted novolac resins can be as discussed and described in U.S. Pat. Nos. 5,670,571 and 6,906,130, and U.S. Patent Application Publication No. 2008/0280787.

The melamine component of a melamine-aldehyde polymer can be provided in many forms. For example, solid melamine, such as prill, and/or melamine solutions can be used. Although melamine is specifically mentioned, the melamine can be totally or partially replaced with other aminotriazine compounds. Other suitable aminotriazine compounds can include substituted melamines, or cycloaliphatic guanamines, or mixtures thereof. Substituted melamines include the alkyl melamines and aryl melamines which can be mono-, di-, or tri-substituted. In the alkyl substituted melamines, each alkyl group can contain 1-6 carbon atoms and, preferably 1-4 carbon atoms. Typical examples of some of the alkyl-substituted melamines are monomethyl melamine, dimethyl melamine, trimethyl melamine, monoethyl melamine, and 1-methyl-3-propyl-5-butyl melamine. In the aryl-substituted melamines, each aryl group can contain 1-2 phenyl radicals and, preferably, 1 phenyl radical. Typical examples of an aryl-substituted melamines are monophenyl melamine and diphenyl melamines.

In preparing a melamine-aldehyde resin, the formaldehyde and the melamine component can be reacted in an aqueous mixture under alkaline conditions using known techniques and equipment. The melamine-aldehyde resin can be made using a molar excess of formaldehyde (along with any other reactive aldehyde component(s)) relative to the melamine component, e.g., melamine. The molar ratio of formaldehyde to melamine (F:M) in the melamine-formaldehyde resin can range from about 0.3:1 to about 6:1, about 0.5:1 to about 4:1, about 0.8:1 to about 5:1, about 1.1:1 to about 6:1, from about 1.3 to about 5:1, or from about 1.5:1 to about 4:1. When synthesized, such resins typically contain a low level of residual “free” melamine component and a much larger amount of residual “free,” i.e. unreacted formaldehyde. Prior to any formaldehyde scavenging, the melamine-formaldehyde resin can be characterized by a free formaldehyde content ranging from about 0.2 wt % to about 18 wt % of the aqueous melamine-formaldehyde resin.

Similar to urea-formaldehyde resins, melamine-formaldehyde and phenol-formaldehyde resins can be prepared from melamine or phenol monomers and formaldehyde monomers or from melamine-formaldehyde or phenol-formaldehyde precondensates. Phenol and melamine reactants, like the urea and formaldehyde reactants are commercially available in many forms and any form that can react with the other reactants and does not introduce extraneous moieties deleterious to the desired reaction and reaction product can be used in the preparation of the resins. Suitable phenol-formaldehyde resins and melamine-formaldehyde resins can include those sold by Georgia Pacific Chemicals LLC (e.g. GP® 2894 and GP® 4878, respectively). These polymers are prepared in accordance with well known methods and contain reactive methylol groups which upon curing form methylene or ether linkages. Such methylol-containing adducts may include N,N′-dimethylol, dihydroxymethylolethylene; N,N′bis(methoxymethyl), N,N′-dimethylolpropylene; 5,5-dimethyl-N,N′dimethylolethylene; N,N′-dimethylolethylene; and the like.

Illustrative resorcinol containing resin can include, but are not limited to resorcinol-aldehyde resins, such as resorcinol-formaldehyde, phenol-resorcinol-aldehyde resins, such as phenol-formaldehyde-resorcinol resins, resorcinol terminated urea-formaldehyde resins, and the like, or any combination. An illustrative resorcinol-formaldehyde resin can include formaldehyde-starved novolac resorcinol-formaldehyde resins that have excess free resorcinol, i.e. a concentration of free resorcinol that exceeds the concentration of free formaldehyde, and thus contribute free resorcinol to the reaction of the A-stage resin. Suitable resorcinol resins include GP® 4221, a resorcinol/formaldehyde resin having an excess free resorcinol, available from Georgia-Pacific Chemicals LLC. Any suitable form of resorcinol can be used. For example, the resorcinol can be in the form of resorcinol solids, in aqueous or organic solutions, or any combination thereof. For resorcinol-aldehyde polymers, when the aldehyde in the resin is formaldehyde, the molar ratio of resorcinol to formaldehyde can range from about 0.6:1 to about 2:1 or about 1:1 to about 1.5:1. The amount of resorcinol can range from about 0.1 wt % to about 10 wt %, based on the amount of formaldehyde.

As used herein, the solids content of the first resin, the second resin, and/or the binder system, as understood by those skilled in the art, can be measured by determining the weight loss upon heating a small sample, e.g., 1-5 grams of the binder system, to a suitable temperature, e.g., 125° C., and a time sufficient to remove the liquid. By measuring the weight of the sample before and after heating, the percent solids in the sample can be directly calculated or otherwise estimated.

The resorcinol containing resins can be combined with one or more modifiers to produce a modified resorcinol containing resin. Illustrative modifiers that can be used to produce a modified resorcinol containing resin can include, but are not limited to, latexes, styrene maleic anhydride, or a combination thereof. Illustrative latexes can include, but are not limited to, vinylpyridine-styrene butadiene resins, polybutadiene dispersions, styrene-butadiene latexes, natural rubber latex, or any combination thereof. Illustrative processes for producing resorcinol containing resins are discussed and described in U.S. Pat. Nos. 2,385,372; 2,488,495; 2,489,336; 3,476,706; 3,839,251; 3,919,151; 4,032,515; 4,314,050; 4,373,062; 4,376,854; 4,608,408; and 6,541,576, 7,049,387; and 7,642,333.

The binder system, in addition to the first resin can include, but is not limited to, the second resin and/or one or more other components. For example, the one or more components or additives can be combined with the first resin to produce the binder system. In another example, the one or more components or additives can be combined with the first resin and the second resin to produce the binder system. Illustrative additives or components that can be combined with the first resin, in addition to or in lieu of the second resin, can include, but are not limited to, waxes and/or other hydrophobic additives, water, filler material(s), extenders, surfactants, release agents, dyes, fire retardants, formaldehyde scavengers, biocides, or any combination thereof. For composite wood products, such as plywood, typical filler material(s) can include, but are not limited to, ground pecan and/or walnut shells, and typical extenders can include, for example, wheat flour. Other suitable extenders can include, but are not limited to, polysaccharides, sulfonated lignins, and the like. Illustrative polysaccharides can include, but are not limited to, starch, cellulose, gums, such as guar and xanthan, alginates, pectin, gellan, or any combination thereof. Suitable polysaccharide starches can include, for example maize or corn, waxy maize, high amylose maize, potato, tapioca, and wheat starch. Other starches such as genetically engineered starches can include, high amylose potato and potato amylopectin starches. Illustrative sulfonated lignins can include, but are not limited to, sodium lignosulfonate and ammonium lignosulfonate. If the binder composition includes one or more additives, the amount of each additive can range from a low of about 0.01 wt % to a high of 50 wt %, based on the total weight of the binder system. For example, the amount of any given component or additive can range from a low of about 0.01 wt %, about 0.05 wt %, about 0.1 wt %, about 0.5 wt %, or about 1 wt % to a high of about 3 wt %, about 5 wt %, about 7 wt %, or about 9 wt %, based on the total weight of the binder system. In another example, the amount of any given additive or component can range from a low of about 1 wt %, about 5 wt %, about 10 wt %, about 15 wt %, or about 20 wt % to a high of about 25 wt %, about 30 wt %, about 35 wt %, about 40 wt %, or about 45 wt %, based on the total weight of the binder system. As such, for a binder system that includes the first and second resins, in addition to or in lieu of adjusting an amount of the first resin and the second resin relative to one another in the binder system, the amount of one or more of the additives, if present, can be adjusted to produce a different binder system. Similarly, for a binder system that includes the first resin and a component other than the second resin, the amount of the first resins and/or the component can be adjusted to produce a different binder system. Adjusting the amount of one or more of the additives, if present, can also at least partially account for a change in one or more of the monitored process variables.

The lignocellulose substrates (material that includes both cellulose and lignin) can include, but is not limited to, straw, hemp, sisal, cotton stalk, wheat, bamboo, sabai grass, rice straw, banana leaves, paper mulberry (i.e., bast fiber), abaca leaves, pineapple leaves, esparto grass leaves, fibers from the genus Hesperaloe in the family Agavaceae jute, salt water reeds, palm fronds, flax, ground nut shells, hardwoods, softwoods, recycled fiberboards such as high density fiberboard, medium density fiberboard, low density fiberboard, oriented strand board, particle board, animal fibers (e.g., wool, hair), recycled paper products (e.g., newspapers, cardboard, cereal boxes, and magazines), or any combination thereof. Suitable woods can include softwoods and/or hardwoods. Illustrative types of wood can include, but are not limited to, alder, ash, aspen, basswood, beech, birch, cedar, cherry, cottonwood, cypress, elm, fir, gum, hackberry, hickory, maple, oak, pecan, pine, poplar, redwood, sassafras, spruce, sycamore, walnut, and willow.

The starting material, from which the lignocellulose substrates can be derived from, can be reduced to the appropriate size or dimensions by various processes such as hogging, grinding, hammer milling, tearing, shredding, and/or flaking. Suitable forms of the lignocellulose substrates can include, but are not limited to, chips, fibers, shavings, sawdust or dust, or the like. The lignocellulose substrates can have a length ranging from a low of about 0.05 mm, about 0.1 mm, about 0.2 mm to a high of about 1 mm, about 5 mm, about 10 mm, about 20 mm, about 30 mm, about 40 mm, about 50 mm, or about 100 mm.

The starting material, from which the lignocellulose substrates can be derived from, can also be formed into the appropriate size or dimensions by skiving, cutting, slicing, sawing, or otherwise removing a thin layer or sheet from a source of lignocellulose material, e.g., a wood log, to produce a veneer substrate or layer. One or more composite products can be produced from two or more veneer. For example, composite products produced with veneer shaped substrates, in finished form, can include those products typically referred to as laminated veneer lumber (“LVL”), laminated veneer boards (“LVB”), and/or plywood.

Depending, at least in part, on the particular veneer product that can incorporate the veneer(s), the veneers can have any suitable shape, e.g., rectangular, circular, or any other geometrical shape. Typically the veneers can be rectangular, and can have a width ranging from a low of about 1 cm, about 5 cm, about 10 cm, about 15 cm, about 20 cm, or about 25 cm to a high of about 0.6 m, about 0.9 m, about 1.2 m, about 1.8 m, or about 2.4 m. The veneers can have a length ranging from a low of about 0.3 m, about 0.6 m, about 0.9 m, about 1.2 m, or about 1.8 m to a high of about 2.4 m, or about 3 m, about 3.6 m, about 4.3 m, about 4.9 m, about 5.5 m, about 6.1 m, about 6.7 m, about 7.3 m, or about 7.9 m. For example, in a typical veneer product such as plywood, the veneers can have a width of about 1.2 m and a length of about 2.4 m. The veneers can have a thickness ranging from a low of about 0.8 mm, about 0.9 mm, about 1 mm, about 1.1 mm or about 1.2 mm to a high of about 3 mm, about 4 mm, about 5 mm, about 6 mm, about 7 mm, about 8 mm, about 9 mm, or about 10 mm.

Illustrative composite wood products or articles produced using the binder compositions discussed and described herein can include, but are not limited to, particle board, fiberboard such as medium density fiberboard (“MDF”) and/or high density fiberboard (“HDF”), plywood such as hardwood plywood and/or softwood plywood, oriented strand board (“OSB”), laminated veneer lumber (“LVL”), laminated veneer boards (“LVB”), and the like.

The binder system can be prepared or produced in close proximity to or at a mill. For example, the binder system can be prepared on-site, where the composite products are produced. In another example, the binder system can be prepared at a facility that can be located within about 0.5 km, about 1 km, about 3 km, about 5 km, about 10 km, about 20 km, about 30 km, or about 50 km of the mill or other production facility where the composite products are produced and the binder can be transported to the mill or other production facility. Preferably, the binder system can be prepared at the location the composite products are made, i.e., on-site. Preparing the binder system on-site can provide the ability to adjust the binder composition as the finished products are being made/produced, in situ. As such, production of the binder system on-site can facilitate a faster adjustment of the composition of the binder system thus reducing the time between the point in time at which a change in a monitored process variable is observed and the point in time when the composition of the binder systems is adjusted in response to the changed process variables and applied to the lignocellulose substrates to produce composite products with the binder system that accounts for the change in monitored process variables.

The production of lignocellulose and/or other particulate containing products can include contacting a plurality of lignocellulose substrates with the binder system. The lignocellulose substrates can be contacted with the binder system by spraying, coating, mixing, brushing, falling film or curtain coater, dipping, soaking, or the like. After contacting the plurality of lignocellulose substrates with the binder system, the binder system can be at least partially cured. At least partially curing the binder system can include applying heat and/or pressure thereto. The binder system can also at least partially cure at room temperature and pressure. The lignocellulose substrates contacted with the binder system can be formed into a desired shape, e.g., a board, a woven mat, or a non-woven mat. The substrates contacted with the binder system can be formed into a desired shape before, during, and/or after partial curing of the binder system. Depending on the particular product, the substrates contacted with the binder system can be pressed before, during, and/or after the binder system at least partially cures. For example, the substrates contacted with the binder system can be consolidated or otherwise formed into a desired shape, if desired pressed to a particular density and thickness, and heated to at least partially cure the binder system. In another example, a blended furnish, i.e., a mixture of the substrates and the binder system, can be extruded through a die (extrusion process) and heated to at least partially cure the binder system.

As used herein, the terms “curing,” “cured,” and similar terms are intended to embrace the structural and/or morphological change that occurs in a the binder system, such as by covalent chemical reaction (crosslinking), ionic interaction or clustering, improved adhesion to the substrate, phase transformation or inversion, and/or hydrogen bonding when the binder system is at least partially cured to cause the properties of a flexible, porous substrate, such as a wood or other lignocellulose containing substrate, to which an effective amount of the binder system has been applied, to be altered.

The binder system can be applied to the plurality of substrates immediately after preparation of the binder system or within about 1 minute, about 5 minutes, about 10 minutes, about 30 minutes, about 1 hour, about 2 hours, about 4 hours, about 8 hours, about 12 hours, about 16 hours, about 20 hours, or about 24 hours after preparation of the binder system. For example, application of the binder system to the substrates can be carried out in less than about 6 hours, less than about 5 hours, less than about 3 hours, less than about 1 hour, less than about 45 minutes, less than about 30 minutes, less than about 15 minutes, or less than about 10 minutes after combining the first and second resins to produce the binder system.

The amount of the binder system applied to the lignocellulose substrates can range from a low of about 3 wt %, about 4 wt %, about 5 wt % or about 6 wt % to a high of about 10 wt %, about 12 wt %, about 15 wt %, or about 20 wt %, based on a weight of the wood based or wood containing material. For example, a lignocellulose composite product can contain from about 5 wt % to about 15 wt %, about 8 wt % to about 14 wt %, about 10 wt % to about 12 wt %, or about 7 wt % to about 10 wt % binder composition, based on a dry weight of the lignocellulose substrates.

The pressure applied in producing the product can depend, at least in part, on the particular product. For example, the amount of pressure applied to a particle board process can range from about 1 MPa to about 5 MPa or from about 2 MPa to about 4 MPa. In another example, the amount of pressure applied to a MDF product can range from about 2 MPa to about 7 MPa or from about 3 MPa to about 6 MPa. The temperature the product can be heated to produce an at least partially cured product can range from a low of about 100° C., about 125° C., about 150° C., or about 170° C. to a high of about 180° C., about 200° C., about 220° C., or about 250° C. The length of time the pressure can be applied can range from a low of about 30 seconds, about 1 minute, about 3 minutes, about 5 minutes, or about 7 minutes to a high of about 10 minutes, about 15 minutes, about 20 minutes, or about 30 minutes, which can depend, at least in part, on the particular product and/or the particular dimensions, e.g., thickness of the product.

The binder systems discussed and described herein can meet or exceed the formaldehyde emission standards required by the California Air Resources Board (“CARB”) Phase 1 (less than 0.18 parts per million “ppm” formaldehyde for particleboard), and Phase 2 (less than 0.09 ppm formaldehyde for particleboard). The binder compositions discussed and described herein can also meet or exceed the formaldehyde emission standards required by the Japanese JIS/JAS F*** (does not exceed 0.5 mg/L formaldehyde for particleboard), Japanese JIS/JAS F**** (does not exceed 0.3 mg/L formaldehyde for particleboard), European E1, and European E2 standards.

By monitoring the one or more process variables, evaluating the one or more process variables, and adjusting the composition of the binder system in response to the evaluated process variables can improve the production of the composite products while also reducing or minimizing formaldehyde emissions. For example, the composite products can be produced to meet and/or maximize desired final product specifications such as internal bond strength while at the same time reducing the amount of formaldehyde emitted from the composite product by optimizing the composition of the binder system based on the one or more process variables.

The FIGURE depicts an illustrative system 100 for varying a composition of a binder system used to produce one or more lignocellulose composite products 170, according to one or more embodiments. The system 100 can include one or more resin vessels (two are shown 105, 110), one or more flow meters or flow control devices (two are shown 115, 120), one or more mixers (one is shown 125), one or more binder system applicators or binder system application units (one is shown 130), and one or more composite product forming units (one is shown 160). The system 100 can also include one or more process variable monitors (one is shown 135) and one or more control systems or control units (one is shown 140).

A first resin 106 and a second resin 111 can be stored or otherwise contained in the first and second resin vessels 105, 110, respectively. The first resin via line 107 and the second resin via line 113 can be introduced to the mixer 125. The first and second resins 106, 111 can be mixed, blended, or otherwise combined with one another to produce a first binder system via line 127. The first and/or second flow control devices 115, 120 can control or adjust the amounts of the first and second resins introduced via lines 107, 111, respectively, to the mixer 125. The first binder system via line 127 can be introduced to the binder system application unit 130, which can distribute or disperse the first binder system 145 such that the first binder system 145 contacts the plurality of lignocellulose substrates 150 to produce a first substrate/binder system mixture or “first mixture” 153. The first mixture 153 can be introduced, e.g., the first conveyor 155, to the composite product forming unit 160. The composite product forming unit 160 can form or shape the first mixture 153 to a desired dimension and at least partially cure the first binder system to produce a first composite product 170. The first composite product 170 can be recovered from the composite product forming unit 160 and transported, e.g., via conveyor 165, to further processing, storage, or the like.

The first and second flow control devices 115, 120 can be manually controlled or adjusted and/or automatically controlled or adjusted. For example, personnel can manually adjust the first and/or second flow control devices 115, 120 to control the amount of the first and/or second resins via lines 106, 111, respectively, that can be introduced via lines 107, 113, respectively, to the mixer 125. In another example, the control unit 140 can automatically adjust the first and/or second flow control devices 115, 120 to control the amount of the first and/or second resins via lines 106, 111, respectively, that can be introduced via lines 107, 113, respectively, to the mixer 125. Adjusting the flow rate of the first and/or second resins 106, 111 through the first and second flow control devices 115, 120, respectively, the control unit 140 and/or manually can be based, at least in part, on one or more monitored process variables.

The process variable monitor 135 can measure, determine, or estimate one or more process variables before, during, and/or after production of the composite products 170. The process variable monitor 135 can include, for example, a temperature sensor, a formaldehyde emission sensor, or other sensor capable of monitoring one or more process variables. Alternatively or in addition to the process variable monitor 135 one or more personnel can estimate, measure, or otherwise determine one or more process variables. As such, the one or more process variables can be monitored via the process variable monitor 135, personnel, or a combination thereof.

The process variable monitor 135 can transmit the estimated or measured process variable(s) via line 137 to the control unit 140. The control unit 140 can evaluate the monitored process variable(s) to determine an appropriate composition for the binder system 145 that can be based, at least in part, on the monitored process variables introduced thereto via line 137. The control unit 140 can control the amount of the first resin 106 in line 107 and/or the amount of the second resin 111 in line 113 via lines 141 and 143, respectively. The lines 141 and 143 can be physical connections, e.g., a wire, cable, or other physical device, and/or a wireless connection, e.g., sound, light, and/or radio frequency energy. A signal can be output via lines 141 and/or 143 to communicate to the first and/or second flow control device 115, 120 any adjustment, if any, in the amount of the first and/or second resin via lines 107, 113 introduced to the mixer 125.

If the evaluation of the one or more monitored process variables indicates a change in the composition of the first binder system should be changed, then a second binder system can be produced. The amount of the first resin 107 and/or the amount of the second resin via line 113 used to produce the first binder system via line 127 can be adjusted in response to the one or more monitored process variables and introduced to the mixer 125. The differing amount(s) of the first and/or second resins via lines 107, 113 can be mixed, blended, or otherwise combined with one another to produce the second binder system via line 127. The second binder system in line 127 can have a different weight ratio of the first resin to the second resin as compared to the first binder system. The second binder system via line 127 can then be used to produce one or more second composite products. More particularly, the second binder system via line 127 can be introduced to the binder system application unit 130, which can distribute or disperse the second binder system 145 such that the second binder system 145 contacts the plurality of lignocellulose substrates 150 to produce a second substrate/binder system mixture or “second mixture” 153. The second mixture 153 can be introduced, e.g., the first conveyor 155, to the composite product forming unit 160. The composite product forming unit 160 can form or shape the second mixture 153 to a desired dimension and at least partially cure the second binder system to produce a second composite product 170. The second composite product 170 can be recovered from the composite product forming unit 160 and transported, e.g., via conveyor 165, to further processing, storage, or the like.

The first and second resin vessels 105, 110, respectively, can be an open vessel or a closed vessel. The first and second resin vessels 105, 110 can include one or more mixing devices such as one or more mechanical/power mixers and/or acoustic mixers such as sonic mixers. The first and second resin vessels 105, 110 can include a cooling and/or heating jacket disposed about and/or coil disposed therein for maintaining a temperature of the resin at a desired temperature or within a desired temperature range. In another example, the first and/or second resin vessels 105, 110 can be a taker truck or other transportation vehicle such as a rail car. In another example, the first and/or second resin vessels 105, 110 can be a reaction vessel in which the first and/or second resins 106, 111 is produced by reacting two or more reactants with one another to produce the first and/or second resin 106, 111, respectively.

The flow control devices 115, 120 can be any suitable device, system, or combination of devices and/or systems adapted or configured to control the amount of the first and second resins in lines 107, 111, respectively, introduced to the mixer 125. Illustrative flow control devices can include, but are not limited to, valves, nozzles, pumps, and the like. For example, valves suitable for use as the flow control devices 115, and/or 120 can include ball valves, gate valves, needle valves, butterfly valves, globe valves, and the like.

The mixer 125 for combing the first and the second resins introduced via lines 107, 111, respectively can include any device, system, apparatus, or any combination of devices, systems, and/or apparatus suitable for batch, intermittent, and/or continuous mixing of two or more components. The mixer 125 can be or include one or more open vessels or containers. For example, the mixer can be or include one or more enclosed bodies or containers capable of carrying out the mixing under vacuum, at atmospheric pressure, and/or at a pressure greater than atmospheric pressure. The mixer can also be or include one or more pipes, tubes, conduits, or other structures, capable of mixing any two or more of the components of the binder composition. For example, any two or more of the binder composition components can be mixed inline, e.g., a conduit of a binder composition delivery or application system.

Illustrative mixing, blending, or other combining device, system, apparatus, or combinations thereof can include, but is not limited to, mechanical mixer agitation, ejectors, static mixers, mechanical/power mixers, shear mixers, sonic mixers, or combinations thereof. The mixer 125 can include one or more heating jackets, heating coils, internal heating elements, cooling jacks, cooling coils, internal cooling elements, or the like, which can heat and/or cool the first and second resins and/or the binder system.

The binder system application unit 130 can include any one or more systems, devices, or combinations thereof capable of applying the binder system in line 127 to the plurality of lignocellulose substrates 150 to produce the furnish 153. For example, the application unit 130 can be or include on or more nozzles that can spray, mist, drip, foam, or otherwise urge the binder system in line 127 into contact with the plurality of lignocellulose substrates 150 to produce the furnish 153. In another example the application unit 130 can be or include one or more brushes or other application devices capable of applying the binder system in line 127 to the plurality of lignocellulose substrates 150 to produce the furnish 153. In another example, the binder system application unit 130 can be or include a vessel with one or more mixers or stirs to which the binder via line 127 and the plurality of lignocellulose substrates 150 can be introduced and contacted with one another to produce the furnish 153.

The composite product forming unit 160 can include any one or systems, devices, or combinations thereof capable of at least partially curing the binder system. The composite product forming unit 160 can also be capable of shaping or otherwise controlling a final dimension or shape of the composite product. For example, the composite product forming unit 160 can be or include a press. The press can be heated to apply heat to the furnish 153. In another example, the composite product forming unit 160 be or include a system or apparatus capable of extruding the furnish 153 between two platens of a heated die. Such an extrusion process can be used to produce particleboard, for example.

### EXAMPLES

In order to provide a better understanding of the foregoing discussion, the following non-limiting examples are offered. Although the examples may be directed to specific embodiments, they are not to be viewed as limiting the invention in any specific respect. All parts, proportions, and percentages are by weight unless otherwise indicated.

A series of binder systems (Ex. 1-6) that contained a first resin and a second resin at different weight ratios were prepared and the effect on cure speed as the ratio of the first and second resin changed was determined. All three resins, namely, Resin A, Resin B, and Resin C, were liquid phenol-formaldehyde resins. The molar ratio of phenol to formaldehyde for all three resins (A, B, and C) was essentially the same. The difference between Resins A and B and Resins C and B was the degree of resin advancement, which is shown in Table 1. The degree of advancement for Resins A and C were high compared to the degree of advancement for Resin B. The binder system properties are shown in Table 1 below.

TABLE 1
Binder Systems

| | | Resin | | Viscosity, | Relative |
|---|---|---|---|---|---|
| | | Concentration | Non- | cP at | Advance- |
| Example | Resins | (wt %) | Volatiles | 25 C. | ment |
| Ex. 1 | A | 70 | 30 | 225 | High |
| | B | 30 | 60 | 100-200 | Low |
| Ex. 2 | A | 60 | 30 | 225 | High |
| | B | 40 | 60 | 100-200 | Low |
| Ex. 3 | A | 50 | 30 | 225 | High |
| | B | 50 | 60 | 100-200 | Low |
| Ex. 4 | C | 70 | 35 | 240 | High |
| | B | 30 | 60 | 100-200 | Low |
| Ex. 5 | C | 60 | 35 | 240 | High |
| | B | 40 | 60 | 100-200 | Low |
| Ex. 6 | C | 50 | 35 | 240 | High |
| | B | 50 | 60 | 100-200 | Low |

Panels were made having dimensions of 16 inches by 16 inches by 0.75 inches thick. The furnish used to produce all panels was Southern Yellow Pine having a moisture concentration of about 7 wt % to about 8 wt %. Wax in an amount of 1 wt %, based on the weight of the furnish, was added. The binder systems were applied to the furnish in an amount of 3.5 wt %, based on the weight of the furnish. Each panel was pressed at a temperature of 400° F. for the time shown in Tables 2 and 3. The test or process conditions were maintained as constant as possible, except for the change in composition of the binder systems and the varying press times. The furnish temperature, pressure applied to form the panel, binder system application amount, and the like were maintained as close to constant as possible.

The change in internal bond strength (IB), boiled internal bond strength (BIB) at various press times ranging from 3.25 minutes to 4.25 minutes were determined and are reported in Table 2 in units of pounds per square inch (lbs/in²). The internal bond strength was measured according to ASTM D1037. The boiled internal bond strength was measured. The results are shown in Table 2 below.

TABLE 2
Panel Strength

| | Panel | IB (BIB) | IB (BIB) | IB (BIB) | IB (BIB) | IB (BIB) |
|---|---|---|---|---|---|---|
| | Density | Strength | Strength | Strength | Strength | Strength |
| Example | (lbs/ft³) | at 3.25 min. | at 3.50 min. | at 3.75 min. | at 4.00 min. | at 4.25 min. |
| Ex. 1 | 41.9 | 41 (17) | 41 (18) | 46 (23) | | |
| Ex. 2 | 44.0 | | 51 (26) | 52 (26) | 58 (24) | |
| Ex. 3 | 42.9 | | 40 (20) | 54 (25) | 55 (29) | |
| Ex. 4 | 42.7 | | | 49 (18) | 60 (21) | 59 (23) |
| Ex. 5 | 41.6 | | | 58 (24) | 65 (30) | 53 (31) |
| Ex. 6 | 42.4 | | | 37 (27) | 64 (33) | 51 (21) |

As shown in Table 2, as the binder system changed composition both the internal bond strength and the boiled internal bond strength were affected. The change in boiled thickness swell at various press times ranging from 3.25 minutes to 4.25 minutes was also determined and the results are shown in Table 3 below.

TABLE 3
Panel Swell

| | | Boiled | Boiled | | | |
|---|---|---|---|---|---|---|
| | | Thick- | Thick- | | | |
| | Average | ness | ness | Boiled | Boiled | Boiled |
| | Slat | Swell | Swell | Thickness | Thickness | Thickness |
| Exam- | Density | at 3.25 | at 3.50 | Swell at | Swell at | Swell at |
| ple | (lbs/ft³) | min | min | 3.75 min | 4.00 min | 4.25 min |
| Ex. 1 | 42.4 | 28.5 | 25.9 | 28.1 | | |
| Ex. 2 | 42.6 | | 26.6 | 24.9 | 26.7 | |
| Ex. 3 | 42.7 | | 26.8 | 25.1 | 22.7 | |
| Ex. 4 | 43.3 | | | 30.0 | 30.1 | 26.8 |
| Ex. 5 | 43.0 | | | 27.3 | 23.6 | 26.3 |
| Ex. 6 | 42.8 | | | 25.6 | 22.4 | 27.9 |

As shown in Table 3, as the binder system changes composition both the boiled thickness swell of the panels produced with each binder system was affected.

Embodiments of the present disclosure further relate to any one or more of the following paragraphs:

1. A method for preparing a binder system, comprising: combining a first resin and a second resin to produce a first binder system; applying the first binder system to a first plurality of lignocellulose substrates; at least partially curing the first binder system to produce a first composite product; monitoring one or more process variables; evaluating the one or more monitored process variables; and adjusting an amount of the first resin, the second resin, or both combined with one another in response to the evaluation of the one or more monitored process variables to produce a second binder system.

2. A method for preparing a binder system, comprising: combining a first resin and a second resin to produce a first binder system, wherein the first binder system has a first weight ratio of the first resin to the second resin, based on a solids weight of the first and second resins; contacting a first plurality of lignocellulose substrates with the first binder system to produce a first mixture; at least partially curing the first binder system in the first mixture to produce a first composite product; monitoring one or more process variables; evaluating the one or more monitored process variables; adjusting an amount of the first resin, the second resin, or both combined with one another to produce a second binder system, wherein the second binder system has a second weight ratio of the first resin to the second resin, based on the solids weight of the first and second resins, wherein the adjustment in the amount of the first resin, the second resin, or both is based on the evaluation of the one or more monitored process variables; contacting a second plurality of lignocellulose substrates with the second binder system to produce a second mixture; and at least partially curing the second binder system in the second mixture to produce a second composite product.

3. The method according to paragraph 1 or 2, further comprising: applying at least a portion of the second binder system to a second plurality of lignocellulose substrates; and at least partially curing the second binder system to produce a second composite product.

4. The method according to any one of paragraphs 1 to 3, wherein evaluating the one or more monitored process variables comprises comparing at least one of the one or more monitored process variables to a predetermined database containing one or more previously acquired values of the at least one of the one or more monitored process variables.

5. The method according to any one of paragraphs 1 to 4, wherein evaluating the one or more monitored process variables comprises manipulating the one or more process variables to provide at least one manipulated process variable; and comparing the manipulated process variable to a predetermined database containing one or more previously acquired values of the at least one manipulated process.

6. The method according to any one of paragraphs 1 to 5, wherein the first binder and the second binder contain at least one different compound with respect to one another.

7. The method according to any one of paragraphs 1 to 6, wherein the first binder and the second binder have at least one different property with respect to one another.

8. The method according to any one of paragraphs 1 to 7, wherein the first binder and the second binder have different properties with respect to one another when at least partially cured.

9. The method according to any one of paragraphs 1 to 8, wherein the one or more process variables is monitored before the first resin and the second resin are combined to produce the first binder system.

10. The method according to any one of paragraphs 1 to 9, wherein the one or more process variables is monitored when the first resin and the second resin are combined to produce the first binder system.

11. The method according to any one of paragraphs 1 to 10, wherein the one or more process variables is monitored after the first resin and the second resin are combined to produce the first binder system.

12. The method according to any one of paragraphs 1 to 11, wherein at least one of the one or more process variables is monitored before the first resin and the second resin are combined to produce the first binder system, and at least one of the one or more process variables is monitored when the first resin and the second resin are combined to produce the first binder system.

13. The method according to any one of paragraphs 1 to 12, wherein at least one of the one or more process variables is monitored before the first resin and the second resin are combined to produce the first binder system, and at least one of the one or more process variables is monitored after the first resin and the second resin are combined to produce the first binder system.

14. The method according to any one of paragraphs 1 to 13, wherein at least one of the one or more process variables is monitored when the first resin and the second resin are combined to produce the first binder system, and at least one of the one or more process variables is monitored after the first resin and the second resin are combined to produce the first binder system.

15. The method according to any one of paragraphs 1 to 14, wherein at least one of the one or more process variables is monitored before the first resin and the second resin are combined to produce the first binder system, wherein at least one of the one or more process variables is monitored when the first resin and the second resin are combined to produce the first binder system, and wherein at least one of the one or more process variables is monitored after the first resin and the second resin are combined to produce the first binder system.

16. The method according to any one of paragraphs 1 to 15, wherein the one or more process variables comprises at least one of: a press speed, an environmental temperature, an environmental humidity, a cure speed of the first binder system, a formaldehyde emissions of the binder, a composition of the first resin, a composition of the second resin, or any combination thereof.

17. The method according to any one of paragraphs 1 to 16, wherein the one or more process variables comprise at least one of: a press speed, an environmental temperature, an environmental humidity, a cure speed of the first binder system, a formaldehyde emissions of the binder, a composition of the first resin, a composition of the second resin, a moisture content in the first plurality of lignocellulose substrates, a moisture content of the second plurality of lignocellulose substrates, a temperature of the first plurality of lignocellulose substrates, a temperature of the second plurality of lignocellulose substrates, a contact rate of the first binder system to the first plurality of lignocellulose substrates, a contact rate of the second binder system to the second plurality of lignocellulose substrates, a cure temperature of the first composite product, a cure temperature of the second composite product, a pressure applied to the first plurality of lignocellulose substrates during the at least partial curing of the first binder system, a pressure applied to the second plurality of lignocellulose substrates during the at least partial curing of the second binder system, a density of the first lignocellulose composite product, a density of the second lignocellulose composite product, a thickness of the first lignocellulose composite product, a thickness of the second lignocellulose composite product, a formaldehyde emission of the first composite product, a formaldehyde emission of the second composite product, an internal bond strength of the first composite product, an internal bond strength of the second composite product, or any combination thereof.

18. The method according to any one of paragraphs 1 to 17, wherein the one or more monitored process variables comprises at least a first monitored process variable and a second monitored process variable, and wherein the first and second monitored process variables are monitored at the same time or at a different time with respect to one another.

19. A system for producing a binder system, comprising: a first resin vessel in fluid communication with a first flow control device; a second resin vessel in fluid communication with a second flow control device; and a mixer adapted to combine the first resin and the second resin to produce a binder system, wherein the first and second flow control devices are configured to adjust an amount of a first resin and a second resin combined within the mixer to produce the binder system, and wherein the amount of the first resin and the second resin combined with one another is based on an evaluation of one or more monitored process variables.

20. The system according to paragraph 19, further comprising one or more binder system applicators configured to apply the binder system to a plurality of lignocellulose substrates.

21. The system according to paragraph 19 or 20, wherein the first flow control device, the second flow control device, or both are manually adjustable.

22. The system according to any one of paragraphs 19 to 21, further comprising one or more control units in communication with one or more process variable monitors.

23. The system according to any one of paragraphs 19 to 22, wherein the one or more control units is configured to automatically adjust the first flow control device, the second flow control device, or both based on the evaluation of the one or more monitored process variables.

24. The system according to any one of paragraphs 19 to 23, wherein the one or more control units evaluates the one or more monitored process variables by comparing at least one of the one or more monitored process variables to a predetermined database containing one or more previously acquired values for the at least one of the one or more monitored process variables.

25. The system according to any one of paragraphs 19 to 24, wherein the one or more control units evaluates the one or more monitored process variables by manipulating the one or more process variables to provide at least one manipulated process variable; and comparing the manipulated process variable to a predetermined database containing one or more previously acquired values for the at least one manipulated process variable.

26. A method for preparing a binder system, comprising: combining at least a first resin and a component to produce a first binder system, wherein the component comprises a second resin, a wax, water, a filler material, an extender, a surfactant, a release agent, a dye, a fire retardant, a formaldehyde scavenger, a biocide, or any combination thereof; applying at least a portion of the first binder system to a first plurality of lignocellulose substrates; at least partially curing the first binder system to produce a first composite product; monitoring one or more process variables; evaluating the one or more monitored process variables; and adjusting an amount of the first resin, the component, or both combined with one another in response to the evaluation of the one or more monitored process variables to produce a second binder system.

27. The method according to paragraph 26, further comprising applying at least a portion of the second binder system to a second plurality of lignocellulose substrates; and at least partially curing the second binder system to produce a second composite product.

28. The method according to paragraph 26 or 27, wherein evaluating the one or more monitored process variables comprises comparing at least one of the one or more monitored process variables to a predetermined database containing one or more previously acquired values of the at least one of the one or more monitored process variables.

29. The method according to any one of paragraphs 26 to 28, wherein evaluating the one or more monitored process variables comprises manipulating the one or more process variables to provide at least one manipulated process variable; and comparing the manipulated process variable to a predetermined database containing one or more previously acquired values of the at least one manipulated process.

30. The method according to any one of paragraphs 26 to 29, wherein the first binder and the second binder contain at least one different compound with respect to one another.

31. The method according to any one of paragraphs 26 to 30, wherein the first binder and the second binder have at least one different property with respect to one another.

32. The method according to any one of paragraphs 26 to 31, wherein the first binder and the second binder have different properties with respect to one another when at least partially cured.

33. The method according to any one of paragraphs 26 to 32, wherein the one or more process variables is monitored before the first resin and the second resin are combined to produce the first binder system.

34. The method according to any one of paragraphs 26 to 33, wherein the one or more process variables is monitored when the first resin and the second resin are combined to produce the first binder system.

35. The method according to any one of paragraphs 26 to 34, wherein the one or more process variables is monitored after the first resin and the second resin are combined to produce the first binder system.

36. The method according to any one of paragraphs 26 to 35, wherein at least one of the one or more process variables is monitored before the first resin and the second resin are combined to produce the first binder system, and at least one of the one or more process variables is monitored when the first resin and the second resin are combined to produce the first binder system.

37. The method according to any one of paragraphs 26 to 36, wherein at least one of the one or more process variables is monitored before the first resin and the second resin are combined to produce the first binder system, and at least one of the one or more process variables is monitored after the first resin and the second resin are combined to produce the first binder system.

38. The method according to any one of paragraphs 26 to 37, wherein at least one of the one or more process variables is monitored when the first resin and the second resin are combined to produce the first binder system, and at least one of the one or more process variables is monitored after the first resin and the second resin are combined to produce the first binder system.

39. The method according to any one of paragraphs 26 to 38, wherein at least one of the one or more process variables is monitored before the first resin and the second resin are combined to produce the first binder system, wherein at least one of the one or more process variables is monitored when the first resin and the second resin are combined to produce the first binder system, and wherein at least one of the one or more process variables is monitored after the first resin and the second resin are combined to produce the first binder system.

40. The method according to any one of paragraphs 26 to 39, wherein the one or more process variables comprises at least one of: a press speed, an environmental temperature, an environmental humidity, a cure speed of the first binder system, a formaldehyde emissions of the binder, a composition of the first resin, a composition of the second resin, or any combination thereof.

41. The method according to any one of paragraphs 26 to 40, wherein the one or more monitored process variables comprises at least a first monitored process variable and a second monitored process variable, and wherein the first and second monitored process variables are monitored at the same time or at a different time with respect to one another.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A binder system for making lignocellulose composite products, comprising:
a first resin comprising an aldehyde based resin, and
a second resin comprising (a) a mixture of Maillard reactants, (b) a copolymer of a vinyl aromatic derived unit and at least one of maleic anhydride and maleic acid, (c) a polyamide-epichlorohydrin polymer, (d) an adduct or polymer of styrene, at least one of maleic anhydride and maleic acid, and at least one of an acrylic acid and an acrylate, (e) a polyacrylic acid based binder, (f) a polyvinyl acetate, (g) a polymeric methylene diisocyanate, or (h) any combination thereof,
wherein the binder system comprise about 75 wt % to about 99.9 wt % of the first resin, based on a combined solids weight of the first resin and the second resin.

2. The binder system of claim 1, wherein the second resin comprises the polymeric methylene diisocyanate.

3. The binder system of claim 1, wherein the aldehyde based resin comprises a phenol-formaldehyde resin and the second resin comprises the polymeric methylene diisocyanate.

4. The binder system of claim 1, wherein the aldehyde based resin comprises a phenol-formaldehyde resin having a molar ratio of formaldehyde to phenol of about 1.1:1 to about 4:1, and wherein the second resin comprises the polymeric methylene diisocyanate.

5. The binder system of claim 1, wherein the aldehyde based resin comprises a phenol-formaldehyde resin and the second resin comprises the polymeric methylene diisocyanate, and wherein the binder system comprises 85 wt % to about 99.9 wt % of the first resin, based on the combined solids weight of the first resin and the second resin.

6. The binder system of claim 1, wherein:
the aldehyde based resin comprises a phenol-formaldehyde resin having a molar ratio of formaldehyde to phenol of about 1.1:1 to about 4:1,
the second resin comprises the polymeric methylene diisocyanate, and
the binder system comprises 85 wt % to about 99.9 wt % of the first resin, based on the combined solids weight of the first resin and the second resin.

7. The binder system of claim 1, wherein the binder system further comprises about 1 wt % to about 15 wt % of an extender and about 1 wt % to about 15 wt % of a filler, based on a total weight of the binder system.

8. The binder system of claim 1, wherein the binder system further comprises about 3 wt % to about 9 wt % of an extender and about 3 wt % to about 9 wt % of a filler, based on a total weight of the binder system.

9. The binder system of claim 8, wherein the extender comprises wheat flour and the filler comprises ground pecan shells, ground walnut shells, or mixture thereof.

10. The binder system of claim 1, wherein the binder system further comprises about 0.01 wt % to about 1 wt % of a surfactant and about 10 wt % to about 50 wt % of water, based on a total weight of the binder system.

11. The binder system of claim 1, wherein the binder system further comprises about 0.5 wt % to about 9 wt % of an extender, about 0.01 wt % to about 1 wt % of a surfactant, and about 10 wt % to about 50 wt % of water, based on a total weight of the binder system.

12. The binder system of claim 1, wherein:
the binder system further comprises about 0.5 wt % to about 9 wt % of an extender, about 0.01 wt % to about 1 wt % of a surfactant, and about 10 wt % to about 50 wt % of water, based on a total weight of the binder system,
the aldehyde based resin comprises a phenol-formaldehyde resin having a molar ratio of formaldehyde to phenol of about 1.1:1 to about 4:1,
the second resin comprises the polymeric methylene diisocyanate, and
the binder system comprises 85 wt % to about 99.9 wt % of the first resin, based on the combined solids weight of the first resin and the second resin.

13. A blended furnish, comprising:
a plurality of lignocellulose substrates and a binder system, wherein the binder system comprises:
a first resin comprising an aldehyde based resin, and
a second resin comprising (a) a mixture of Maillard reactants, (b) a copolymer of a vinyl aromatic derived unit and at least one of maleic anhydride and maleic acid, (c) a polyamide-epichlorohydrin polymer, (d) an adduct or polymer of styrene, at least one of maleic anhydride and maleic acid, and at least one of an acrylic acid and an acrylate, (e) a polyacrylic acid based binder, (f) a polyvinyl acetate, (g) a polymeric methylene diisocyanate, or (h) any combination thereof,
wherein the binder system comprise about 75 wt % to about 99.9 wt % of the first resin, based on a combined solids weight of the first resin and the second resin.

14. The blended furnish of claim 13, wherein the aldehyde based resin comprises a phenol-formaldehyde resin having a molar ratio of formaldehyde to phenol of about 1.1:1 to about 4:1 and the second resin comprises the polymeric methylene diisocyanate.

15. The blended furnish of claim 13, wherein:
the aldehyde based resin comprises a phenol-formaldehyde resin having a molar ratio of formaldehyde to phenol of about 1.1:1 to about 4:1,
the second resin comprises polymeric methylene diisocyanate, and
the binder system comprises 85 wt % to about 99.9 wt % of the first resin, based on the combined solids weight of the first resin and the second resin.

16. The blended furnish of claim 13, wherein:
the binder system further comprises about 0.5 wt % to about 9 wt % of an extender, about 0.01 wt % to about 1 wt % of a surfactant, and about 10 wt % to about 50 wt % of water, based on a total weight of the binder system,
the aldehyde based resin comprises a phenol-formaldehyde resin having a molar ratio of formaldehyde to phenol of about 1.1:1 to about 4:1,
the second resin comprises polymeric methylene diisocyanate, and
the binder system comprises 85 wt % to about 99.9 wt % of the first resin, based on a combined solids weight of the first resin and the second resin.

17. The blended furnish of claim 16, wherein the blended furnish comprises about 3 wt % to about 15 wt % of the binder system, based on a dry weight of the plurality of lignocellulose substrates.

18. A method for preparing a lignocellulose composite product, comprising:
contacting a plurality of lignocellulose substrates with a binder system to produce a mixture, wherein the binder system comprises:
a first resin comprising an aldehyde based resin, and
a second resin comprising (a) a mixture of Maillard reactants, (b) a copolymer of a vinyl aromatic derived units and at least one of maleic anhydride and maleic acid, (c) a polyamide-epichlorohydrin polymer, (d) an adduct or polymer of styrene, at least one of maleic anhydride and maleic acid, and at least one of an acrylic acid and an acrylate, (e) a polyacrylic acid based binder, (f) polyvinyl acetate, (g) polymeric methylene diisocyanate, or (h) any combination thereof,
wherein the binder system comprises about 75 wt % to about 99.9 wt % of the first resin, based on a combined solids weight of the first resin and the second resin; and
heating the mixture to a temperature of about 100° C. to about 200° C. for about 30 seconds to about 10 minutes to at least partially cure the binder system in the mixture to produce a lignocellulose based composite product.

19. The method of claim 18, wherein:
the aldehyde based resin comprises a phenol-formaldehyde resin having a molar ratio of formaldehyde to phenol of about 1.1:1 to about 4:1,
the second resin comprises the polymeric methylene diisocyanate, and
the binder system comprises 85 wt % to about 99.9 wt % of the first resin, based on the combined solids weight of the first resin and the second resin.

20. The method of claim 18, wherein:
the binder system further comprises about 0.5 wt % to about 9 wt % of an extender, about 0.01 wt % to about 1 wt % of a surfactant, and about 10 wt % to about 50 wt % of water, based on a total weight of the binder system,
the aldehyde based resin comprises a phenol-formaldehyde resin having a molar ratio of formaldehyde to phenol of about 1.1:1 to about 1:4,
the second resin comprises the polymeric methylene diisocyanate,
the binder system comprises 85 wt % to about 99.9 wt % of the first resin, based on the combined solids weight of the first resin and the second resin,
the mixture comprises about 3 wt % to about 15 wt % of the binder system, based on a dry weight of the plurality of lignocellulose substrates, and
the lignocellulose based composite product is particle board, fiberboard, plywood, oriented strand board, or laminated veneer lumber.
